(19) United States
(12) Patent Application Publication
(10) Pub. No.: US 2013/0227647 A1
(43) Pub. Date: Aug. 29, 2013

(54) SHARED NETWORK ACCESS VIA A PEER-TO-PEER LINK

(71) Applicant: APPLE INC., (US)

(72) Inventors: Tito Thomas, San Jose, CA (US); Charles F. Dominguez, Redwood City, CA (US); Andreas Wolf, San Mateo, CA (US)

(73) Assignee: APPLE INC., Cupertino, CA (US)

(21) Appl. No.: 13/773,091

(22) Filed: Feb. 21, 2013

Related U.S. Application Data
(60) Provisional application No. 61/604,037, filed on Feb. 28, 2012.

(51) Int. Cl. H04L 29/06

(52) U.S. Cl. CPC H04L 63/08
USPC 726/3

(57) ABSTRACT

An electronic device receives a request for access to the infrastructure network (and, more generally, a ‘resource’) from the other electronic device via a peer-to-peer link. In response to the request, the electronic device determines that it has access to the infrastructure network, and provides a response to the other electronic device via the peer-to-peer link indicating that the electronic device has access to the infrastructure network. Then, the electronic device establishes secure communication with the other electronic device, and provides access information to the other electronic device via the peer-to-peer link using the secure communication. This access information facilitates access to the infrastructure network.

### CROSS REFERENCE TO RELATED APPLICATION

This application claims priority under 35 U.S.C. §119(e) to U.S. Provisional Application Ser. No. 61/604,037, entitled “Shared Network Access via a Peer-to-Peer Link,” by Tito Thomas, Charles F. Dominguez and Andreas Wolf, Attorney docket number APL-P13329USP1, filed on Feb. 28, 2012, the contents of which is herein incorporated by reference.

### BACKGROUND

1. Field

The described embodiments relate to electronic devices. More specifically, the described embodiments relate to wireless communication among electronic devices.

2. Related Art

Modern electronic devices often communicate with each other using wireless networks. For example, a typical electronic device can include a networking subsystem that transmits and receives packets using a network interface, such as: a cellular network interface (UMTS, LTE, etc.), a wireless local area network interface (e.g., such as those described in the Institute of Electrical and Electronics Engineers (IEEE) standards 802.11), and/or another type of wireless interface.

Many popular communication networks used by electronic devices (such as those described by IEEE standards 802.11) are centered on access points that are coupled to the Internet and/or other electronic devices and resources. These access points are typically at fixed locations, and setting them up often requires configuration of the access points. In the discussion that follows, communication networks that include such access points are referred to as ‘infrastructure networks.’

A particular infrastructure network is usually identified by a name (such as a service set identifier or SSID). In order to connect to an infrastructure network, an electronic device typically must first discover the name and request to connect to the infrastructure network. For example, an electronic device can broadcast an advertising frame that includes the name of an infrastructure network, and another electronic device can monitor for the advertising frame to detect the name. After discovering the name, the other electronic device may send a request to the electronic device to connect to the infrastructure network. Once these electronic devices are connected to the same infrastructure network, they can communicate with each other via an access point. For example, each packet sent from electronic device A to electronic device B usually must pass through the access point.

However, in order to connect to an infrastructure network, the electronic device typically must provide access information to the other electronic device, such as a password and, more generally, credentials and/or configuration information (which are sometimes referred to as ‘access information’). Providing this access information is often cumbersome for a user of the electronic device and can present a security risk because the access information can be intercepted by a third party. Furthermore, if the other electronic device is not currently configured to communicate using the wireless communication technique that is used in a particular infrastructure network (for example, the other electronic device has recently been purchased), it can be very difficult for the other electronic device to communicate with the electronic device. Therefore, it can be very difficult for the other electronic device to receive the access information. Additionally, a wireless electronic device may not have a user interface (for example, the wireless electronic device may be a so-called ‘headless device’). In this case, the access information cannot be manually entered by the user.

### SUMMARY

The described embodiments include an electronic device that wirelessly communicates with another electronic device and provides access to an infrastructure network. In the described embodiments, the electronic device receives a request for access to the infrastructure network (and, more generally, a ‘resource’) from the other electronic device via a peer-to-peer link. In response to the request, the electronic device determines that it has access to the infrastructure network, and provides a response to the other electronic device via the peer-to-peer link indicating that the electronic device has access to the infrastructure network. Then, the electronic device establishes secure communication with the other electronic device, and provides access information to the other electronic device via the peer-to-peer link using the secure communication. This access information facilitates access to the infrastructure network.

In an alternate mode of discovery, in some embodiments, instead of receiving the request, determining that the electronic device has access to the infrastructure network, and providing the response, the electronic device provides a message to the other electronic device via the peer-to-peer link indicating that the electronic device has access to the infrastructure network. In response to the message, the electronic device receives a request for access to the infrastructure network from the other electronic device via the peer-to-peer link. Then, the electronic device establishes the secure connection and provides the access information.

Note that the electronic device and/or the other electronic device may include a cellular telephone. Furthermore, the access information may include: a password (and, more generally, credentials) for the infrastructure network and/or configuration information for using the infrastructure network.

In some embodiments, establishing the secure communication involves exchanging an encryption key between the electronic device and the other electronic device.

Moreover, prior to establishing the secure communication, the electronic device may authenticate the other electronic device and/or a user of the other electronic device. For example, the authentication may involve: receiving approval from a user of the electronic device, receiving an identifying image from the other electronic device (for example, an image of the user of the other electronic device which may be recognized by the user of the electronic device), receiving an identifier of the other electronic device, receiving a digital certificate from the other electronic device, receiving an access code from the other electronic device, and/or receiving a response from the other electronic device to a challenge provided by the electronic device.

Another embodiment provides a method that includes at least some of the operations performed by the electronic device.

Another embodiment provides a computer-program product for use with the electronic device. This computer-program product includes instructions for at least some of the operations performed by the electronic device.

### BRIEF DESCRIPTION OF THE FIGURES

FIG. 1 presents a block diagram illustrating a system that includes a group of electronic devices wirelessly communicating in accordance with an embodiment of the present disclosure.

FIG. 2 presents a block diagram illustrating a system that includes a group of electronic devices wirelessly communicating in accordance with an embodiment of the present disclosure.

FIG. 3 presents a flowchart illustrating a method for providing access to the infrastructure network of FIGS. 1 and 2 in accordance with an embodiment of the present disclosure.

FIG. 4 presents a flowchart illustrating a method for providing access to the infrastructure network of FIGS. 1 and 2 in accordance with an embodiment of the present disclosure.

FIG. 5 presents a block diagram illustrating an electronic device in FIGS. 1 and 2 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

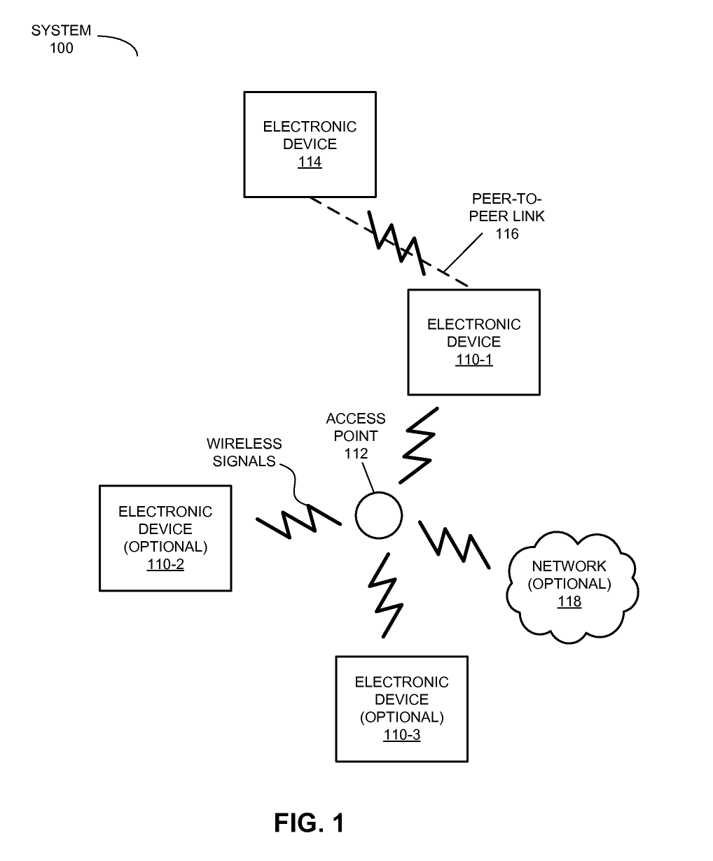

FIG. 1 presents a block diagram illustrating a system 100 that includes a group of one or more electronic devices 110 wirelessly communicating with each other and/or an optional network 118 (such as the Internet). In particular, electronic devices 110 (such as cellular telephones) communicate information with each other in an infrastructure network (such as those described by IEEE standards 802.11) that includes access points, such as access point 112. This information may be communicated in packets that are encapsulated with frames. A frame may include a header with communication information, such as a name of the infrastructure network (for example, an SSID), and a payload with data.

If an electronic device 114 (such as a cellular telephone) wishes to access or connect to the infrastructure network (and, more generally, a ‘resource,’ such as a networked resource that is password protected), it may send a request for access to one of electronic devices 110. (In general, the resource that electronic device 114 wishes to access need not only be an infrastructure network, but may be other resources, such as a cellular-telephone network or a printer attached to one of electronic devices 110.) In particular, electronic device 114 may use or may establish a peer-to-peer link 116 with one of electronic devices 110 (such as electronic device 110-1), and may provide the request (for example, as a payload in a frame). Note that during communication via peer-to-peer link 116, electronic devices 110-1 and 114 communicate frames to each other directly. Therefore, the communication does not occur via access point 112 or another of electronic devices 110 (i.e., the packets are not retransmitted). Typically, a peer-to-peer link is not connected to the Internet, and there is no network name. (Indeed, there is no ‘network’ per se, and electronic devices can participate or leave a peer-to-peer link seamlessly.) Examples of peer-to-peer link 116 include: Apple Wireless Direct Link or AWDL (from Apple Inc. of Cupertino, Calif.) and Bluetooth™ (from the Bluetooth Special Interest Group of Kirkland, Wash.).

After receiving the request, electronic device 110-1 may determine that it has access to the resource, which in this example is the infrastructure network. Then, electronic device 110-1 provides a response to electronic device 114 via peer-to-peer link 116 indicating that electronic device 110-1 has access to the infrastructure network (for example, the response may be communicated as a payload in a frame).

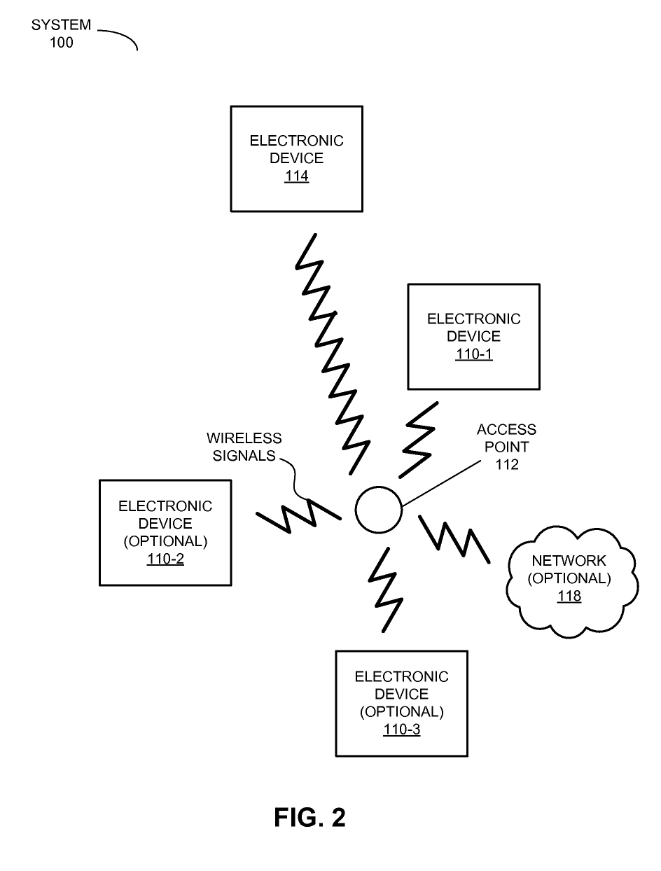

Subsequently, electronic device 110-1 establishes secure communication with electronic device 114, and provides access information to electronic device 114 via peer-to-peer link 116 using the secure communication (for example, the access information may be communicated as a payload in a frame). This access information facilitates access by electronic device 114 to the infrastructure network. For example, as shown in FIG. 2, which illustrates system 100 after access has been granted, electronic device 114 may access optional network 118 (such as the Internet) via access point 112. Referring back to FIG. 1, note that the access information may include a password for the infrastructure network, credentials for the infrastructure network and/or configuration information for electronic device 114 (such as addressing information and/or channel information) that will allow electronic device 114 to connect to the infrastructure network.

In some embodiments, establishing the secure communication involves exchanging an encryption key between electronic device 110-1 and electronic device 114.

Furthermore, prior to establishing the secure communication, electronic device 110-1 may authenticate electronic device 114 and/or a user of electronic device 114. For example, the authenticating may involve receiving approval from a user of electronic device 110-1, such as when a question asking the user to approve the providing of the access information to electronic device 114 is displayed on electronic device 110-1, and the providing of the access information may be gated by the user's response. Alternatively or additionally, the authentication may involve: receiving and/or displaying an identifying image, such as a picture of a user of electronic device 114 or a picture taken from within the vicinity of both electronic devices 110-1 and 114 (either of which may be recognized and approved by the user of electronic device 110-1); receiving an identifier of electronic device 114 (such as a serial number that indicates electronic device 114 is owned by a trusted user); receiving a digital certificate from electronic device 114 (such as a certificate from a third party that indicates electronic device 114 can be trusted to access the infrastructure network); receiving an access code from electronic device 114 (such as a personal identification number or PIN); and/or receiving a response from electronic device 114 to a challenge provided by electronic device 110-1 (such as a security question). Authentication can also be implicit by physical proximity of the electronic devices 110-1 and 114. In this case, only an electronic device that is sufficiently close (e.g., when both electronic devices 110-1 and 114 are literally touching each other or are not more than a few inches apart) to the providing electronic device will access to the resource be granted. Note that proximity of electronic devices 110-1 and 114 can be determined using a variety of characteristics (such as electrical conductivity, capacitance, mutual inductance, wireless signal strength, etc.).

In an alternate mode of discovery, in some embodiments, instead of receiving the request, determining that electronic device 110-1 has access to the infrastructure network, and providing the response, electronic device 110-1 provides a message (for example, as a payload in a frame) to electronic device 114 via peer-to-peer link 116 indicating electronic device 110-1 has access to the infrastructure network, e.g., electronic device 110-1 may broadcast that it has access to the infrastructure network. In response to the message, electronic device 110-1 may receive a request (for example, as a payload in a frame) for access to the infrastructure network from electronic device 114 via peer-to-peer link 116. Then, electronic device 110-1 may establish the secure connection with electronic device 114, and may provide the access information to electronic device 114.

In general, note that the initial discovery between electronic device 114 and electronic device 110-1 (using either a push or a pull technique) may involve a different transport technique that the sequent authentication and secure exchange of credentials to the resource. For example, discovery may be over Bluetooth™ and subsequent exchange may be over AWDL or another peer-to-peer technique.

By leveraging peer-to-peer link 116, electronic device 114 may receive the access information that facilitates subsequent use of the infrastructure network. This access technique may occur without explicit knowledge of or action by the users of either electronic device 110-1 or electronic device 114 (thus, the access technique may be ‘passive,’ i.e., without user action, or ‘actively enabled’ by user action). As a consequence, the access technique may reduce the time and effort needed to convey the access information to electronic device 114. This capability may be particularly useful for electronic devices that do not have a user interface (so-called ‘headless’ devices) or which have user interfaces that may be difficult to use. This ease of use and simplicity may enhance the user experience when connecting to the infrastructure network, thereby increasing customer satisfaction when using the electronic devices.

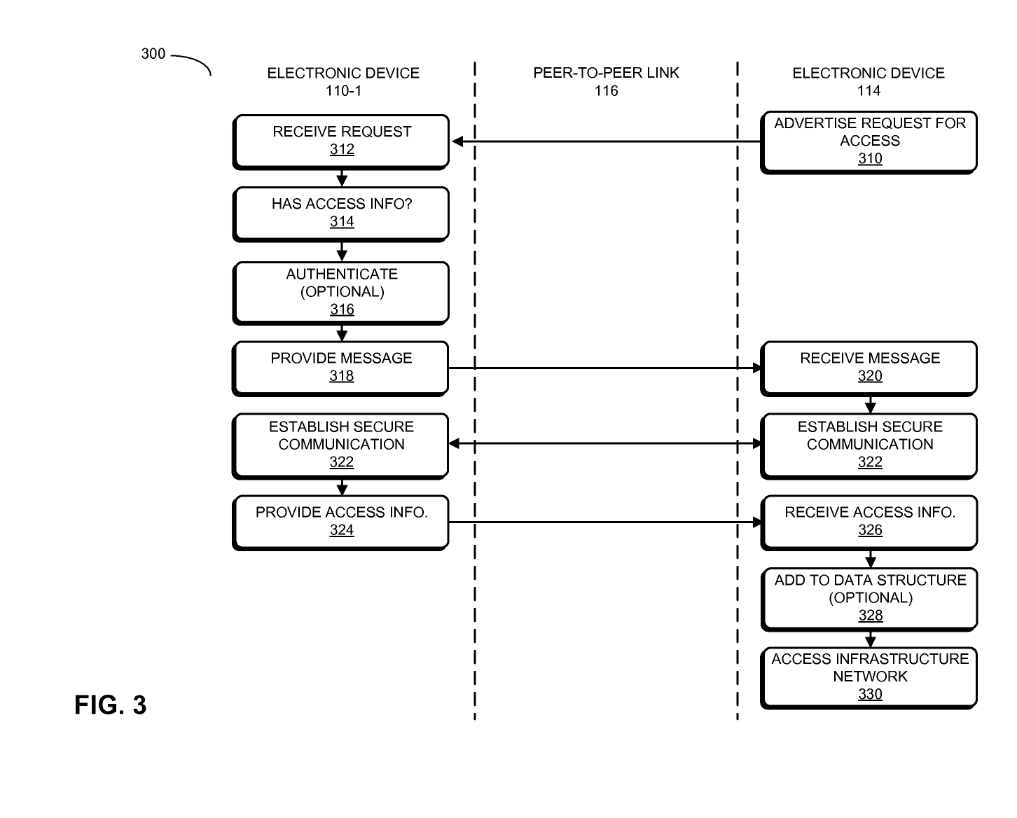

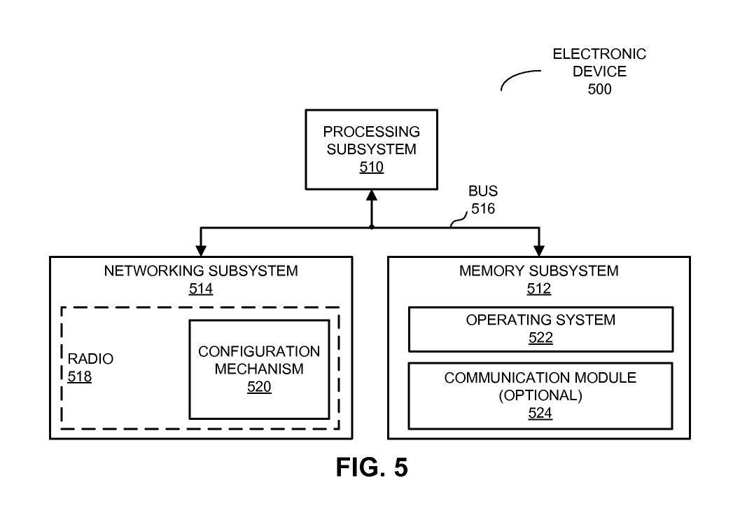

We now further describe the access technique. FIG. 3 presents a flowchart illustrating a method 300 for providing access to the infrastructure network of FIGS. 1 and 2. During this method, electronic device 114 advertises a request for access to a resource (such as the infrastructure network) using peer-to-peer link 116 (operation 310). For example, electronic device 114 may advertise for access in response to a user instruction or command (such as if the user activates a physical button or a virtual icon on a display) or in response to a signal provided by an operating system executing on electronic device 114 (such as operating system 522 stored in memory subsystem 512 in FIG. 5). In particular, in a so-called ‘push’ approach, when a user of electronic device 114 selects a particular infrastructure network that is displayed on electronic device 114, instead of having the user enter a password, electronic device 114 may look for electronic devices that have the password for the infrastructure network. Therefore, method 300 may be performed automatically or may be user initiated.

In response to receiving the request from electronic device 114 (operation 312), electronic device 110-1 may determine if it has access information for the infrastructure network (operation 314) and, if so, may optionally determine if it should provide the access information to electronic device 114. For example, electronic device 110-1 may optionally authenticate (operation 316) electronic device 114 and/or a user of electronic device 114. Thus, in response to receiving the request, electronic device 110-1 may display a prompt to the user of electronic device 110-1 to authorize electronic device 114 to access the infrastructure network.

However, in some embodiments the request message sent by electronic device 114 is formed such that only electronic devices that have the access information will receive it. For example, this could be a particularly formated service request (e.g., in a zero configuration networking standard) to which electronic device 110-1 is subscribed. This may require electronic device 110-1 to only filter for request messages for which it has access information. In this case, operation 314 is obsolete and electronic device 110-1 may need to indicate to electronic device 114 that it has access information in operation 318 (see below). Also, in this case, electronic device 110-1 may start authentication (operation 316) and may establish secure communication (operation 322) with electronic device 114 immediately.

If electronic device 110-1 has the requested access information and if the transaction is authenticated, electronic device 110-1 may provide a message to electronic device 114 indicating that it has the access information via peer-to-peer link 116 (operation 318). After electronic device 114 receives the message (operation 320), electronic devices 110-1 and 114 may establish secure communication via peer-to-peer link 116 (operation 322). For example, electronic devices 110-1 and 114 may exchange: encryption keys, a one-time password (such as a password that is only valid for one login), access information with a time limit (such as a password that expires after an hour) or access information that can only be shared once (i.e., which cannot be reused or becomes invalid if it is retransmitted to another electronic device).

Moreover, after the secure communication is established, electronic device 110-1 may provide the access information to electronic device 114 via peer-to-peer link 116 using the secure communication (operation 324). After receiving the access information (operation 326), electronic device 114 may optionally add the access information (such as credentials) to an internal data structure (operation 328) and may use the access information to access the infrastructure network (operation 330).

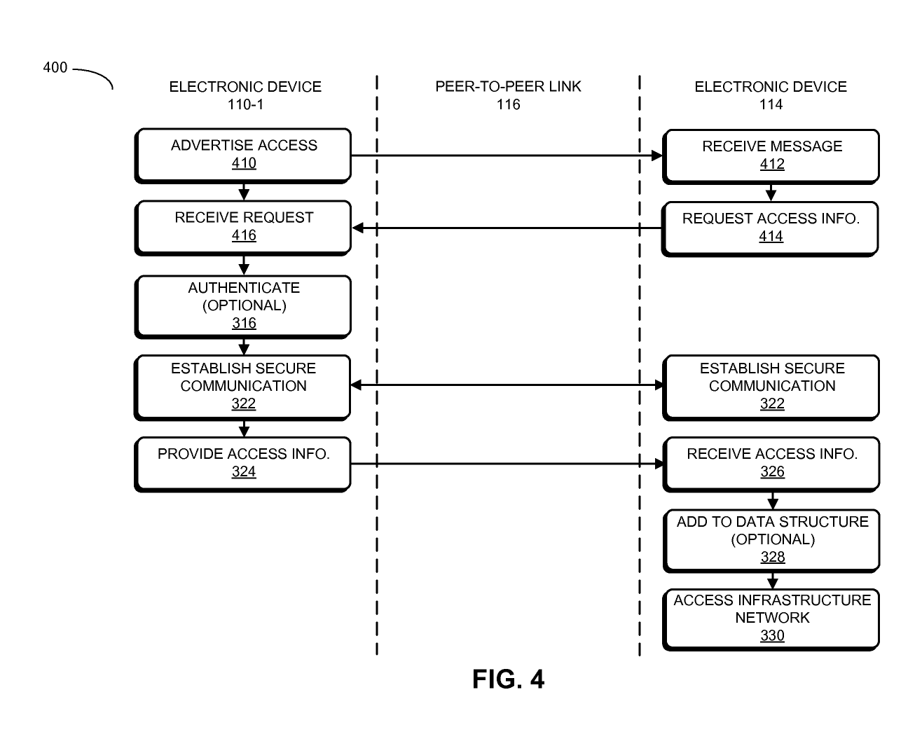

As discussed previously, in some embodiments electronic device 110-1 advertises that it has access to the infrastructure network (instead of electronic device 114 advertising that it wants access to the infrastructure network). This is shown in FIG. 4, which presents a flowchart illustrating a method 400 for providing access to the infrastructure network of FIGS. 2 and 3. During this method, electronic device 110-1 advertises that it has access to a resource (such as the infrastructure network) using peer-to-peer link 116 (operation 410). For example, electronic device 110-1 may advertise that it has access in response to a user instruction or command (such as if the user of electronic device 110-1 activates a physical button or a virtual icon on a display) or in response to a signal provided by an operating system executing on electronic device 110-1. Note that electronic device 110-1 may: always advertise that it has access to the infrastructure network; only advertise that it has access while it is connected to the infrastructure network; or only advertise when a user of electronic device 110-1 intends to share the access information (for example, by visiting a share password screen displayed on electronic device 110-1). Thus, method 400 may be performed automatically or may be user initiated.

In response to receiving this message (operation 412), electronic device 114 may request access information for the infrastructure network via peer-to-peer link 116 (operation 414). For example, in a so-called ‘poll’ approach, when a user of electronic device 114 selects a particular infrastructure network that is displayed on electronic device 114, instead of having the user enter a password, electronic device 114 may look for electronic devices that advertise that they have the password for the infrastructure network. When one of these electronic devices is discovered by electronic device 114 (i.e., when the message is received), this information may be presented to the user of electronic device 114, who may select the discovered electronic device (in this example, electronic device 110-1), thereby initiating the subsequent operations in method 400. In another embodiment of the poll technique, the information need not be presented to the user. Instead, method 400 may immediately continue with an access request to device 110-1.

After receiving the request (operation 416), electronic device 110-1 may optionally determine if it should provide the access information to electronic device 114. For example, electronic device 110-1 may authenticate (operation 316) electronic device 114 and/or a user of electronic device 114. Thus, in response to receiving the request, electronic device 110-1 may display a prompt to the user of electronic device 110-1 to authorize electronic device 114 to access he infrastructure network.

If electronic device 110-1 authenticates the transaction, electronic devices 110-1 and 114 may establish secure communication (operation 322) via peer-to-peer link 116. Moreover, after the secure communication is established, electronic device 110-1 may provide the access information to electronic device 114 via peer-to-peer link 116 using the secure communication (operation 324). After receiving the access information (operation 326), electronic device 114 may optionally add the access information (such as credentials) to an internal data structure (operation 328) and may use the access information to access the infrastructure network (operation 330).

In some embodiments of methods 300 (FIG. 3) and/or 400, there may be additional or fewer operations. Moreover, the order of the operations may be changed, and/or two or more operations may be combined into a single operation.

We now further describe the electronic devices. FIG. 5 presents a block diagram illustrating an electronic device 500, such as one of electronic devices 110 and 114 in FIGS. 1 and 2. Electronic device 500 may include processing subsystem 510, memory subsystem 512, and networking subsystem 514.

Processing subsystem 510 may include one or more devices that perform computational operations. For example, processing subsystem 510 can include one or more microprocessors, application-specific integrated circuits (ASICs), microcontrollers, and/or programmable-logic devices. Processing subsystem 510 may execute an operating system 522 (stored in memory subsystem 512) that includes procedures (or a set of instructions) for handling various basic system services for performing hardware-dependent tasks.

Memory subsystem 512 may include one or more devices for storing data and/or instructions for processing subsystem 510 and networking subsystem 514. For example, memory subsystem 512 can include dynamic random access memory (DRAM), static random access memory (SRAM), and/or other types of memory. (More generally, memory subsystem 512 may include volatile memory and/or non-volatile memory that are configured to store information.) In addition, memory subsystem 512 can include mechanisms for controlling access to the memory. In some embodiments, memory subsystem 512 includes a memory hierarchy that comprises one or more caches coupled to a memory in electronic device 500. Alternatively or additionally, in some of these embodiments one or more of the caches is located in processing subsystem 510.

Moreover, memory subsystem 512 may be coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device may be used to store less frequently used data.

Networking subsystem 514 may include one or more devices that couple to and communicate on a wired and/or wireless network (e.g., that perform network operations). For example, networking subsystem 514 can include: a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi™ networking system), an Ethernet or IEEE 802.3 networking system, and/or another networking system.

Networking subsystem 514 may include processors, controllers, radios/antennas, sockets/plugs, and/or other devices used for coupling to, communicating on, and handling data and events for each supported networking system. In the following description, we refer to the mechanisms used for coupling to, communicating on, and handling data and events on the network for each network system collectively as the ‘interface’ or ‘network interface’ for the network system. Note that in some embodiments, a ‘network’ between the devices does not yet exist. Therefore, electronic device 500 may use the mechanisms in networking subsystem 514 for performing simple wireless communication between the electronic devices, e.g., transmitting packets or frames and receiving packets transmitted by other electronic devices via a peer-to-peer link.

Within electronic device 500, processing subsystem 510, memory subsystem 512, and networking subsystem 514 may be coupled together using bus 516. Bus 516 may be an electrical, optical, or electro-optical connection that the subsystems can use to communicate commands and data among one another. Although only one bus 516 is shown for clarity, different embodiments can include a different number or configuration of electrical, optical, or electro-optical connections among the subsystems.

Electronic device 500 can be (or can be included in) any device with at least one network interface. For example, electronic device 500 can be (or can be included in): a personal or desktop computer, a laptop computer, a server, a work station, a client computer (in a client-server architecture), a media player (such as an MP3 player), an appliance, a subnotebook/netbook, a tablet computer, a smartphone, a cellular telephone, a piece of testing equipment, a network appliance, a set-top box, a personal digital assistant (PDA), a toy, a controller, a digital signal processor, a game console, a device controller, a computational engine within an appliance, a consumer-electronic device (such as a television), a portable computing device or a portable electronic device, a personal organizer, and/or another electronic device. In this discussion, a ‘computer’ or ‘computer system’ includes one or more electronic devices that are capable of manipulating computer-readable data or communicating such data between two or more computer systems over a network.

Although we use specific components to describe electronic device 500, in alternative embodiments, different components and/or subsystems may be present in electronic device 500. For example, electronic device 500 may include one or more additional processing subsystems 510, memory subsystems 512, and/or networking subsystems 514. Additionally, one or more of the subsystems may not be present in electronic device 500. Moreover, in some embodiments, electronic device 500 may include one or more additional subsystems that are not shown in FIG. 5. For example, electronic device 500 can include, but is not limited to: a display subsystem for displaying information on a display, a data collection subsystem, an audio and/or video subsystem, an alarm subsystem, a media processing subsystem, and/or an input/output (I/O) subsystem. Also, although separate subsystems are shown in FIG. 5, in some embodiments, some or all of a given subsystem can be integrated into one or more of the other subsystems in electronic device 500 and/or positions of components in electronic device 500 can be changed.

We now further describe networking subsystem 514. As illustrated in FIG. 5, networking subsystem 514 may include radio 518 and configuration mechanism 520. Radio 518 may include hardware and/or software mechanisms that are used for transmitting wireless signals from electronic device 500 and receiving signals at electronic device 500 from other electronic devices. Aside from the mechanisms herein described, radios, such as radio 518, are generally known in the art and hence are not described in detail.

Although networking subsystem 514 can include any number of radios 518, embodiments with one radio 518 are herein described. Note, however, that the radios 518 in multiple-radio embodiments function in a similar way to the described single-radio embodiments.

Configuration mechanism 520 in radio 518 may include one or more hardware and/or software mechanisms used to configure the radio to transmit and/or receive on a given channel (e.g., a given carrier frequency). For example, in some embodiments the configuration mechanism 520 can be used to switch radio 518 from monitoring and/or transmitting on a given channel in the 2.4 GHz and 5 GHz band of channels described in the IEEE 802.11 specification to monitoring and/or transmitting on a different channel. (Note that ‘monitoring’ as used herein comprises receiving signals from other electronic devices and possibly performing one or more processing steps on the received signals, e.g., determining if the received signal comprises a frame with a message or a request, etc.)

Networking subsystem 514 may enable electronic device 500 to wirelessly communicate with another electronic device. This can comprise transmitting (e.g., multicasting) advertising frames in packets on wireless channels to enable electronic devices to make initial contact, followed by exchanging subsequent data/management frames (perhaps based on the information in the initially multicast advertising frames) to establish and/or join an existing wireless network (such as an infrastructure network), establish a communication session (e.g., a Transmission Control Protocol/Internet Protocol session, etc.), configure security options (e.g., Internet Protocol Security), and/or exchange data/management frames for other reasons. Note that an advertising frame may include information that enables electronic device 500 to determine one or more properties of another electronic device. Using the information, electronic device 500 can determine at least how/when to communicate with the other electronic device. Similarly, a data/management frame may communicate to the other electronic device at least how/when to communicate with electronic device 500.

Additionally, networking subsystem 514 may enable electronic device 500 to wirelessly communicate with another electronic device using a peer-to-peer link, such as AWDL. AWDL is an ad-hoc peer-to-peer protocol that allows peer-to-peer multicast and unicast data-frame exchanges, which can be integrated with higher-level protocols such as a zero configuration networking standard in order to perform peer and service discovery. Moreover, AWDL provides a synchronization mechanism that makes use of periodic synchronization frames that are transmitted by a subset of AWDL electronic devices. The synchronization mechanism may provide time synchronization (so that AWDL electronic devices periodically rendezvous during a window of time or an ‘availability window’ during which they must be ready to receive broadcast and unicast data frames) and channel synchronization (which allows AWDL electronic devices to converge on a common channel and during a common period of time, i.e., the availability window).

In the described embodiments, processing a frame (and, more generally, a payload) in electronic device 500 involves: receiving wireless signals with the encoded/included frame; decoding/extracting the frame from the received wireless signals to acquire a message or a request; and processing the frame to determine information contained in the frame.

In some embodiments, the access technique is implemented using low-level hardware, such as in a physical layer, a link layer and/or a network layer in a network architecture. For example, the access technique may, at least in part, be implemented in a media access control layer. However, in other embodiments at least some of the operations in the access technique are performed by one or more programs modules or sets of instructions (such as optional communication module 524 stored in memory subsystem 512), which may be executed by processing subsystem 510. (In general, the access technique may be implemented more in hardware and less in software, or less in hardware and more in software, as is known in the art.) The one or more computer programs may constitute a computer-program mechanism. Furthermore, instructions in the various modules in memory subsystem 512 may be implemented in: a high-level procedural language, an object-oriented programming language, and/or in an assembly or machine language. Note that the programming language may be compiled or interpreted, e.g., configurable or configured, to be executed by processing subsystem 510.

In the preceding description, we refer to ‘some embodiments.’ Note that ‘some embodiments’ describes a subset of all of the possible embodiments, but does not always specify the same subset of the embodiments.

Note that the described embodiments are not intended to be limited to accessing existing infrastructure networks, such as the current IEEE 802.11 wireless channels or to the network scheme described in IEEE 802.11. For example, some embodiments can use the newly proposed 60 GHz band of the 802.11 specification (i.e., using the IEEE 802.1 lad standard).

The foregoing description is intended to enable any person skilled in the art to make and use the disclosure, and is provided in the context of a parti-cular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic-device-implemented method for providing access to an infrastructure network, comprising:
receiving a request for access to the infrastructure network from the other electronic device via a peer-to-peer link in which the electronic device and the other electronic device communicate directly without using an intervening access point, wherein electronic devices in the infrastructure network communicate via the intervening access point;
in response to the request, determining that the electronic device has access to the infrastructure network;
providing a response to the other electronic device via the peer-to-peer link indicating that the electronic device has access to the infrastructure network;
establishing secure communication with the other electronic device; and
providing access information to the other electronic device via the peer-to-peer link using the secure communication, wherein the access information facilitates access to the infrastructure network.

2. The method of claim 1, wherein at least one of the electronic device and the other electronic device includes a cellular telephone.

3. The method of claim 1, wherein the access information includes at least one of: a password for the infrastructure network, configuration information for using the infrastructure network, and credentials for the infrastructure network.

4. The method of claim 1, wherein establishing secure communication involves exchanging an encryption key between the electronic device and the other electronic device.

5. The method of claim 1, wherein, prior to establishing the secure communication, the method further comprises authenticating one of: the other electronic device, and a user of the other electronic device.

6. The method of claim 5, wherein the authenticating involves: receiving approval from a user of the electronic device, receiving an identifying image from the other electronic device, receiving an identifier of the other electronic device, receiving a digital certificate from the other electronic device, receiving an access code from the other electronic device, and receiving a response from the other electronic device to a challenge provided by the electronic device.

7. A computer-program product for use in conjunction with an electronic device, the computer-program product comprising a non-transitory computer-readable storage medium and a computer-program mechanism embedded therein, to provide access to an infrastructure network, the computer-program mechanism including:
instructions for receiving a request for access to the infrastructure network from the other electronic device via a peer-to-peer link in which the electronic device and the other electronic device communicate directly without using an intervening access point, wherein electronic devices in the infrastructure network communicate via the intervening access point;
in response to the request, instructions for determining that the electronic device has access to the infrastructure network;
instructions for providing a response to the other electronic device via the peer-to-peer link indicating that the electronic device has access to the infrastructure network;
instructions for establishing secure communication with the other electronic device; and
instructions for providing access information to the other electronic device via the peer-to-peer link using the secure communication, wherein the access information facilitates access to the infrastructure network.

8. An electronic device, comprising:
a processor;
memory; and
a program module, wherein the program module is stored in the memory and configurable to be executed by the processor to provide access to an infrastructure network, the program module including:
instructions for receiving a request for access to the infrastructure network from the other electronic device via a peer-to-peer link in which the electronic device and the other electronic device communicate directly without using an intervening access point, wherein electronic devices in the infrastructure network communicate via the intervening access point;
in response to the request, instructions for determining that the electronic device has access to the infrastructure network;
instructions for providing a response to the other electronic device via the peer-to-peer link indicating that the electronic device has access to the infrastructure network;
instructions for establishing secure communication with the other electronic device; and
instructions for providing access information to the other electronic device via the peer-to-peer link using the secure communication, wherein the access information facilitates access to the infrastructure network.

9. An electronic device, comprising a networking subsystem, wherein the networking subsystem is configured to:
receive a request for access to the infrastructure network from the other electronic device via a peer-to-peer link in which the electronic device and the other electronic device communicate directly without using an intervening access point, wherein electronic devices in the infrastructure network communicate via the intervening access point;
in response to the request, determine that the electronic device has access to the infrastructure network;
provide a response to the other electronic device via the peer-to-peer link indicating that the electronic device has access to the infrastructure network;
establish secure communication with the other electronic device; and
provide access information to the other electronic device via the peer-to-peer link using the secure communication, wherein the access information facilitates access to the infrastructure network.

10. An electronic-device-implemented method for providing access to a resource, comprising:
receiving a request for access to the resource from the other electronic device via a peer-to-peer link in which the electronic device and the other electronic device communicate directly without using an intervening access point, wherein electronic devices in the infrastructure network communicate via the intervening access point;
in response to the request, determining that the electronic device has access to the resource;
providing a response to the other electronic device via the peer-to-peer link indicating that the electronic device has access to the resource;
establishing secure communication with the other electronic device; and
providing access information to the other electronic device via the peer-to-peer link using the secure communication, wherein the access information facilitates access to the resource.

11. An electronic-device-implemented method for providing access to an infrastructure network, comprising:
providing a message to the other electronic device via the peer-to-peer link indicating that the electronic device has access to the infrastructure network, wherein, via the peer-to-peer link, the electronic device and the other electronic device communicate directly without using an intervening access point, and wherein electronic devices in the infrastructure network communicate via the intervening access point;
in response to the message, receiving a request for access to the infrastructure network from the other electronic device via a peer-to-peer link;
establishing secure communication with the other electronic device; and
providing access information to the other electronic device via the peer-to-peer link using the secure communication, wherein the access information facilitates access to the infrastructure network.

12. The method of claim 11, wherein at least one of the electronic device and the other electronic device includes a cellular telephone.

13. The method of claim 11, wherein the access information includes at least one of: a password for the infrastructure network, configuration information for using the infrastructure network, and credentials for the infrastructure network.

14. The method of claim 11, wherein establishing secure communication involves exchanging an encryption key between the electronic device and the other electronic device.

15. The method of claim 11, wherein, prior to establishing the secure communication, the method further includes authenticating one of: the other electronic device, and a user of the other electronic device.

16. The method of claim 15, wherein the authenticating involves: receiving approval from a user of the electronic device, receiving an identifying image from the other electronic device, receiving an identifier of the other electronic device, receiving a digital certificate from the other electronic device, receiving an access code from the other electronic device, and receiving a response from the other electronic device to a challenge provided by the electronic device.

17. A computer-program product for use in conjunction with an electronic device, the computer-program product comprising a non-transitory computer-readable storage medium and a computer-program mechanism embedded therein, to provide access to an infrastructure network, the computer-program mechanism including:
instructions for providing a message to the other electronic device via the peer-to-peer link indicating that the electronic device has access to the infrastructure network, wherein, via the peer-to-peer link, the electronic device and the other electronic device communicate directly without using an intervening access point, and wherein electronic devices in the infrastructure network communicate via the intervening access point;
in response to the message, instructions for receiving a request for access to the infrastructure network from the other electronic device via a peer-to-peer link;
instructions for establishing secure communication with the other electronic device; and
instructions for providing access information to the other electronic device via the peer-to-peer link using the secure communication, wherein the access information facilitates access to the infrastructure network.

18. An electronic device, comprising:
a processor;
memory; and
a program module, wherein the program module is stored in the memory and configurable to be executed by the processor to provide access to an infrastructure network, the program module including:
instructions for providing a message to the other electronic device via the peer-to-peer link indicating that the electronic device has access to the infrastructure network, wherein, via the peer-to-peer link, the electronic device and the other electronic device communicate directly without using an intervening access point, and wherein electronic devices in the infrastructure network communicate via the intervening access point;
in response to the message, instructions for receiving a request for access to the infrastructure network from the other electronic device via a peer-to-peer link;
instructions for establishing secure communication with the other electronic device; and
instructions for providing access information to the other electronic device via the peer-to-peer link using the secure communication, wherein the access information facilitates access to the infrastructure network.

19. An electronic device, comprising a networking subsystem, wherein the networking subsystem is configured to:
provide a message to the other electronic device via the peer-to-peer link indicating that the electronic device has access to the resource, wherein, via the peer-to-peer link, the electronic device and the other electronic device communicate directly without using an intervening access point, and wherein electronic devices in the infrastructure network communicate via the intervening access point;
in response to the message, receive a request for access to the resource from the other electronic device via a peer-to-peer link;
establish secure communication with the other electronic device; and
provide access information to the other electronic device via the peer-to-peer link using the secure communication, wherein the access information facilitates access to the resource.

20. An electronic-device-implemented method for providing access to a resource, comprising:
providing a message to the other electronic device via the peer-to-peer link indicating that the electronic device has access to the resource, wherein, via the peer-to-peer link, the electronic device and the other electronic device communicate directly without using an intervening access point, and wherein electronic devices in the infrastructure network communicate via the intervening access point;
in response to the message, receiving a request for access to the resource from the other electronic device via a peer-to-peer link;
establishing secure communication with the other electronic device; and
providing access information to the other electronic device via the peer-to-peer link using the secure communication, wherein the access information facilitates access to the resource.
